(19) United States
(12) Patent Application Publication
(10) Pub. No.: US 2021/0031782 A1
(43) Pub. Date: Feb. 4, 2021

(54) Using ISA System to Immobilize Truck for Security, Regulatory Compliance, or Maintenance

(71) Applicant: 7980302 Canada Inc., Montreal (CA)

(72) Inventors: Jean POULIN, Varennes (CA); George Bassily, Laval (CA); Mathieu Boivin, Mount Royal (CA); Gabriel Paquin Lefebvre, Montreal (CA)

(21) Appl. No.: 16/947,458

(22) Filed: Aug. 3, 2020

Related U.S. Application Data
(60) Provisional application No. 62/881,935, filed on Aug. 1, 2019.

(51) Int. Cl. B60W 40/09; B60W 50/10; H04L 12/40; H04W 4/48

(52) U.S. Cl. CPC B60W 40/09; B60W 50/10; H04L 12/40; B60W 2510/18; H04L 2012/40215; H04L 2012/40273; H04W 4/48

(57) ABSTRACT

A vehicle comprises an intelligent speed adaptor (ISA) system. The ISA system is configurable to limit the allowed speed of the vehicle to a speed determined based at least in part on a currently allowed speed for a speed zone applicable to a current location of the vehicle; and to limit the allowed speed of the vehicle to a nominal speed. The nominal speed results in the effective disengagement and nonoperation of the accelerator of the vehicle. The nominal speed may be 1 kilometer per hour, 1 mile per hour. The nominal speed also may correspond to a speed that results from idling of the engine.

### BACKGROUND OF THE INVENTION

The present invention generally relates to electronic speed management systems for vehicles that are designed to further compliance by drivers with speed limits. The vehicle may be a motor vehicle such as, for example, an automobile, truck, or semi-truck. It is further contemplated that at least some embodiments of the present invention have utilization with not only motor vehicles but also electric vehicles.

Within this context, FIG. 1 is a schematic representation of an exemplary electronic network 100 of a motor vehicle. The network 100 preferably is a controller area network (CAN) comprising a data bus 102 and a plurality of electronic control units (ECUs) 104 connected to the data bus for electronic communications between the ECUs.

Each ECU defines a node of the network, and the complexity of the node can range from a simple I/O device to an embedded computer with a CAN interface and sophisticated software. A node also may comprise a gateway enabling other electronic devices to communicate over a port, such as a USB or Ethernet port, to the devices on the CAN network. Such other electronic devices may comprise, for example, wireless communication interfaces, including cellular communications, for wirelessly communicating with servers and other computing devices connected to the Internet. This enables real time communications between one or more nodes of the controller area network of the vehicle and a remotely located computer, such as a server. This is represented, for example, in FIG. 2 by wireless communication device and antennae 70.

The data bus 102 connecting the nodes may comprise two wires as schematically seen in FIG. 1 and preferably comprises a twisted pair in actual implementation.

A vehicle commonly has a large number of ECUs connected by the data bus 102. Communications utilizing basic CAN protocols are preferred but other higher-level protocols and network technologies are contemplated, including by way of example and not limitation CAN FD, CAN OPEN, OBD2, and SAE J1939, J1708, as well as other communications protocols and technologies whether invented or hereinafter arising. In its broadest scope, the invention is not limited by any specific protocol or network technology, although preferred embodiments preferably are implemented using one or more of the aforementioned technologies. Of the ECUs present in a vehicle, there is generally a powertrain control module (PCM), which traditionally has been referred to as an engine control module (ECM) or engine control unit because such unit controls engine functions such as spark timing, fuel mixture, and emissions. PCM has become a more descriptive term because the PCM on many vehicles also controls the transmission, which is part of the powertrain. In contrast, a transmission control module (TCM) usually is a separate control module responsible for the transmission. The TCM interacts with the PCM/ECM for transmission shifting at appropriate speeds and loads. There also typically is a body control module (BCM)—another major module handling multiple tasks ranging from lighting and other electrical accessories to climate control, keyless entry, anti-theft duties and managing communications between other modules. The functions and specific modules in a vehicle can vary greatly depending on the year, make and model of vehicle, and even its list of options. As used herein a generic reference to a “main control module” or MCM refers to that module in a vehicle which is responsible for and controls engine operations based on communications and can be used to control acceleration or speed of the vehicle. The MCM commonly will be the PCM or ECM.

Other ECUs include: ABS/traction control/stability control modules; airbag (SRS) modules; alarm modules (or chime modules) for anti-theft system; cruise control modules; electronic steering modules; fuel pump control modules; injector driver modules; instrument cluster control modules; keyless entry modules; lighting modules; remote start/immobilizer modules; suspension control modules; transfer case modules for four-wheel drives; wiper motor control modules; and vehicle communication modules. There also can be modules for power windows, power seats, heated/cooled seats, power sliding doors, door locks, sunroofs, and air flow control doors inside the heating ventilation air conditioning (HVAC) system. These are only representative, and many more types of modules exist. Generally speaking, controllers, sensors and actuators typically are or form part of the types of devices connected by a controller area network 100. Indeed, it is contemplated that a node of a controller area network may comprise a subsystem of devices each having one or more electronic or electromechanical components, that a node may consist of a single such component, or any combination thereof.

Additionally, many vehicles now have advanced driver assistance (ADA) systems, which may be OEM or after market. Some ADA systems manage braking, such as collision mitigation systems, and others manage speed. Those that manage speed often are referred to as intelligent speed adaptor (ISA) systems—or sometimes as intelligent speed adaptation systems or intelligent speed assistance systems. ISA systems are in-vehicle systems that commonly are intended and used to increase speed-limit compliance by drivers.

There are three general categories of ISA systems: open ISA systems; half-open ISA systems; and closed ISA systems. Open ISA systems provide an alert (visible and/or audible) to a driver when a speed limit is exceed and rely upon the driver to decrease the vehicle's speed; half-open ISA systems provide an alert and also temporarily limit the vehicle's capability to exceed the speed limit or make it more difficult to exceed the speed limit by the driver, such as by increasing the force countering depression of an accelerator pedal by a driver; and closed ISA systems limit the speed automatically, overriding a driver's actions causing the speeding, such as by controlling fuel delivery, or by altering acceleration control signals that are sent from an acceleration pedal to an electronic throttle controller and/or to the ECM.

Basic ISA systems limit speed of a vehicle to a preset maximum speed independent of extraneous factors including location of the vehicle. The more advanced ISA systems use information regarding location of the vehicle and a speed limit in force at such location in limiting the vehicle's speed to the then current speed limit. Advanced ISA systems may identify dynamic speed limits and limit a vehicle's speed to the then current speed limit for a given time at a given location. Dynamic speed limits may change based on time-dependent factors such as traffic flow and weather conditions. Information can be obtained in advanced ISA systems through use of digital maps incorporating roadway coordinates as well as from databases containing speed limits for road segments in a geographical area, or through other technologies such as optical recognition technology that detects and interprets roadside speed limit signage. Advanced ISA systems thus assists a driver in keeping to the lawful speed limits at all times, particularly as the vehicle travels through different speed zones. This is particularly useful when drivers are in unfamiliar areas or when they pass through areas where dynamic speed limits are in use. GPS-based ISA systems are believed to be perhaps the most effective ISA systems. In such a system, a GPS device detects a vehicle's current location which information is then used to determine the applicable speed limit from, for example, a preloaded database.

A particular ISA system for limiting the maximum speed of a motor vehicle is disclosed in U.S. Pat. No. 8,751,133 to Poulin, the disclosure of which is incorporated herein by reference. An embodiment in accordance with the disclosure of the '133 patent is illustrated in FIG. 2. In this embodiment, an actual throttle sensor signal from the throttle position sensor to the engine control unit is modified by a speed controller or intelligent speed limiter (ISL) 20 in order to prevent the user from driving the vehicle at a speed beyond the actual allowed maximum speed limit. By modifying the throttle sensor signal, when appropriate, the ISL module 20 is able to cause the speed of the vehicle to decrease when the speed limit is exceeded.

With reference to FIG. 2, the ISA system comprises a number of modules defining nodes of the controller area network including: a user identification device 12 for identifying a driver of the vehicle; a navigation device 14, such as a navigation device including global positioning system (GPS) capabilities for determining a position of the vehicle on a road map (map matching); and a speed limit database 16 or cartography database of posted speed limits for respective segments of roads of the map, which database 16 may be updated in real time or provided from an external provider over wireless communications. These components are connected for communications with the ISL module 20, which executes an allowed maximum speed algorithm. The allowed maximum speed algorithm determines in real time an actual allowed maximum speed limit by adding the posted speed limit of the actual road segment, obtained by map matching (matching the GPS data with the speed limit database), to the corresponding user over-speed parameter.

The user identification device 12 includes a data input interface to receive a user identification code from the driver, either via a keypad 32 (user identification and/or password) or a wireless device 32′ (RFID—radio frequency identification) worn by the driver, or the like.

The ISL module 20 also preferably has access to a user database 18 typically including, for each user, a respective user over-speed parameter corresponding to each respective road segment, which parameter could be provided for different types of roads or could be dependent on the corresponding posted speed limits, typically provided in the form of a driver speed profile table or the like.

The ISL module 20 further communicates with: a main control module of the vehicle comprising an engine control module 22; a vehicle speed source 24, such as a vehicle speed sensor; and a throttle position sensor (TPS) 26. When the vehicle speed determined from the vehicle speed source 24 is within a predetermined activation range below the actual allowed maximum speed limit, the controller module 20 modifies the actual throttle sensor signal that is sent from the throttle position sensor 26 to the main control module 22 so as to prevent the driver from driving the vehicle at a speed in excess of the currently allowed speed limit.

Optionally, a customized speed limit database 30, defining additional road(s), road segment(s) or even drivable road network of an entire restricted zone area, or the like, usually not shown nor available in typical cartography databases, could be incorporated into the ISL module 20 via speed limit database 30.

It will be apparent to the Ordinary Artisan that in a CAN network, all nodes receive the communications sent and that in the ISA system of FIG. 2, the ISL module 20 and the main control module 22 each form a node of the controller area network of the vehicle. The throttle position sensor 26 and vehicle speed source 24 also constitute nodes. In order to modify the actual throttle sensor signal that is sent from the throttle position sensor 26 to the main control module 22 so as to prevent the driver from driving the vehicle at a speed in excess of the currently allowed speed limit, the ISL module 20 controls the signals sent by the throttle position sensor 26. This is schematically represented by control line 23.

An alternative embodiment of the ISA system in accordance with the disclosure of the '133 patent is illustrated in FIG. 3. In this embodiment, the throttle position sensor module 26 preferably is coupled for communication with the ISL module 20 rather than the CAN bus so that the signals sent from the throttle position sensor 26 are not received by the main control module 22 until after the ISL module 20 has had the opportunity to modify such signals, if necessary, in order to reduce the speed of the vehicle or limit acceleration of the vehicle so as not to exceed the maximum allowed speed.

The aforementioned embodiments of the ISA system of the '133 patent need to function to prevent speeding regardless of whether cruise control is engaged by a driver; cruise control cannot be permitted to be a workaround for speeding.

Cruise control functionality is provided by a cruise control module 28 that ordinarily would be coupled in communication with the main control module 22 via the CAN bus. FIG. 2 is representative of this arrangement.

In one embodiment, in order for the ISA system to function with the intended effect even when cruise control is engaged, the ISL module 20 takes over control of the cruise control module 28 and allows the setting of the cruise control only at a vehicle speed at or below the actual allowed maximum speed limit and prevents the setting of the cruise control at any vehicle speed above the actual allowed maximum speed limit. This embodiment is represented in FIG. 2, and such control is schematically represented by control line 25 therein.

In FIG. 3, the cruise control module 28 is coupled for communication with the ISL module 20 rather than the CAN bus so that the signals sent from the control module 28 are not received by the main control module 22 until after the ISL module 20 has had the opportunity to modify such signals, if necessary, which is similar to the arrangement of the throttle position sensor module 26. Thus, in both embodiments of FIGS. 2 and 3, a driver is prevented from exceeding the maximum allowed speed using cruise control.

While suitable for its intended purposes, embodiments of the ISA system disclosed in the '133 patent can be commercially difficult to implement due to the required interactions between the ISL module 20 and the cruise control module 28. In particular, there are many different manufacturers and models of cruise control modules, each module of which can vary significantly in its operation and control. Each manufacturer and model thus need to be taken into consideration in either of the implementations of the ISA system of FIGS. 2 and 3.

Accordingly, a need has arisen for improvements in utilization of the ISA system of the '133 patent—and in other similar ISA systems—which improvements lessen or even obviate the necessity to consider the manufacturer or model of a cruise control module that is utilized in a given vehicle while still enabling the ISA system to properly function when the cruise control is engaged. In other words, there is a need for an ISA system, or enablement of an ISA system, that is cruise control agnostic in its operation. This—and other needs—are believed to be addressed by one or more aspects and features of the present invention.

In addition to the foregoing, it should be pointed out that embodiments of the ISA system in accordance with the disclosure of the '133 patent do in fact additionally provide security features. Specifically, the ISA system may prevent a vehicle from being moved by preventing the starting of the vehicle engine in the absence of a valid user identification. Additionally or alternatively, the ISA system may prevent a vehicle from being moved by preventing a signal from the throttle position sensor 26 from being sent to the engine control unit 22.

Such security features of an ISA system are advantageous, especially in view of the fact that these are byproducts of the design of the ISA system and do not accomplish the principal intent of the ISA system of speed-limit compliance by drivers. Nonetheless, to the extent further security features or other benefits can be realized by repurposing use of an ISA system, such extension of the utility of ISA systems would be considered advantageous. One or more aspects and features of the present invention are believed to provide just such extension of the utility of ISA systems.

### SUMMARY OF THE INVENTION

The present invention includes many aspects and features. Moreover, while many aspects and features relate to, and are described in the context of, ADA systems and ISA systems in particular, the present invention also has utility outside of such systems, as will become apparent to the Ordinary Artisan from the disclosure herein.

In a first aspect, a vehicle comprises: a controller area network, a node of the controller area network comprising a main control module and another node of the controller area network comprising a cruise control module; and a controller configured to cause an indication to be made to the MCM that a driver of the vehicle is braking even when a driver of the vehicle is not braking. In this aspect, the MCM disengages cruise control upon such indication being made to the MCM.

In a feature, the controller is configured to cause the indication to be made to the MCM that a driver of the vehicle is braking as a function of determining that the vehicle is speeding. The controller indicates to the MCM that a driver of the vehicle is braking preferably as a function of also determining that cruise control is engaged.

In a feature, the controller comprises a microcontroller.

In a feature, the controller comprises an application specific integrated circuit.

In another aspect, a vehicle comprises: a controller area network, a node of the controller area network comprising a main control module (MCM) and another node of the controller area network comprising a cruise control module; a brake switch forming part of a brake switch circuit with the MCM which brake switch, when closed, indicates to the MCM that a driver of the vehicle is braking; and a controller arranged in parallel with the brake switch and configured to bypass the brake switch to simulate the closing of the brake switch thereby indicating to the MCM that a driver of the vehicle is braking even when the brake switch is not closed. The MCM disengages cruise control upon the indication to the MCM that a driver of the vehicle is braking.

In a feature, the controller indicates to the MCM that a driver of the vehicle is braking as a function of determining that the vehicle is speeding. The controller indicates to the MCM that a driver of the vehicle is braking preferably as a function of also determining that cruise control is engaged.

In a feature, the controller comprises a microcontroller.

In a feature, the controller comprises an application specific integrated circuit.

In another aspect, a vehicle comprises: an advanced driver assistance (ADA) system; and means for causing a signal to be received by a main control module (MCM) in a controller area network of the vehicle which signal indicates to the MCM that a driver of the vehicle is braking. The signal is caused by said means to be received by the MCM when the vehicle is determined to be speeding regardless of whether the driver of the vehicle is actually braking.

In a feature, the ADA system comprises an intelligent speed adaptor (ISA) system.

In a feature, the ADA system comprises a collision mitigation system.

In a feature, the vehicle comprises a cruise control module and the ADA system operates without regard to the cruise control module. Preferably, the signal is caused by said means to be received by the MCM when it is determined also that cruise control is engaged.

In another aspect, a method for simulating braking of a vehicle so as to disengage cruise control comprises the steps of: monitoring whether cruise control is engaged; determining a current speed of the vehicle; determining a currently allowed speed of the vehicle; comparing the determined currently allowed speed of the vehicle to the determined current speed of the vehicle; and when cruise control is determined to be engaged and the determined current speed of the vehicle is within a predetermined range of or exceeds the determined currently allowed speed, causing one or more signals to be sent to a main control module of the vehicle simulating braking by a driver of the vehicle causing the main control module to disengage the cruise control.

In another aspect, a method for simulating braking of a vehicle so as to disengage cruise control comprises the steps of: monitoring whether cruise control is engaged; determining a current set speed of the cruise control; determining a currently allowed speed of the vehicle; comparing the determined currently allowed speed of the vehicle to the determined current set speed of the vehicle; and when cruise control is determined to be engaged and the determined current set speed of the cruise control is within a predetermined range of or exceeds the determined currently allowed speed, causing one or more signals to be sent to a main control module of the vehicle simulating braking by a driver of the vehicle causing the main control module to disengage the cruise control.

In another aspect, a method for simulating braking of a vehicle so as to disengage cruise control comprises the steps of determining a current speed of the vehicle; determining a currently allowed speed of the vehicle; comparing the determined currently allowed speed of the vehicle to the determined current speed of the vehicle; and when the determined current speed of the vehicle is within a predetermined range of or exceeds the determined currently allowed speed, causing one or more signals to be sent to a main control module of the vehicle simulating braking by a driver of the vehicle causing the main control module to disengage any cruise control that may be engaged.

In a feature, the currently allowed speed is a speed limit for the vehicle.

In a feature, the currently allowed speed is a fixed speed limit for a current location of the vehicle.

In a feature, the currently allowed speed is a dynamic speed limit for a current location of the vehicle.

In a feature, the currently allowed speed is a predetermined variance from a speed limit for a current location of the vehicle.

In a feature, the currently allowed speed is determined from a database using GPS coordinates of the vehicle.

In another aspect, a motor vehicle comprises: an intelligent speed adaptor (ISA) system; and means for causing a signal to be received by a main control module (MCM) in a controller area network of the vehicle which signal indicates to the MCM that a driver of the vehicle is braking, wherein the signal is caused by said means to be received by the MCM when the vehicle is determined to be speeding regardless of whether the driver of the vehicle is actually braking. The ISA system is configurable to limit the allowed speed of the vehicle to a speed determined based at least in part on a currently allowed speed for a speed zone applicable to a current location of the vehicle; and to limit the allowed speed of the vehicle to a speed corresponding to idling of the engine, whereby a motor vehicle under heavy load will be immobilized.

In a feature, the ISA system is configured to send and receive communications to and from a remote computer accessible over the Internet.

The ISA system preferably is configured through a user interface provided by a computer on the Internet. Furthermore, the ISA system preferably is configured to allow a different maximum allowed speed for each of a plurality of different speed zones, and preferably is configured to allow an override of a single maximum allowed speed for all of the plurality of different speed zones, the single maximum allowed speed of the override corresponding to idling of the engine. Settings of maximum allowed speeds and an override speed preferably is done by a fleet operator using a settings page of a web portal. An exemplary web portal is shown in FIG. 12 which is used to monitor and adjust settings for ISA systems.

In another feature, a fleet operator immobilizes the vehicle remotely through a web portal provided by the remote computer accessible over the Internet by setting the allowed speed of the vehicle to a speed corresponding to idling of the engine.

In another feature, a program executed by the remote computer accessible over the Internet immobilizes the vehicle by setting the allowed speed of the vehicle to a speed corresponding to idling of the engine upon determination of a predetermined event.

The predetermined event may comprise a determination that maintenance of the vehicle is required; a determination that operation of the vehicle by an identified driver would be out of compliance with legal regulations; or a determination that operation of the vehicle by an identified driver would exceed an allotted number of hours of operation of the vehicle by the driver.

In another aspect, a vehicle comprises an intelligent speed adaptor (ISA) system; and means for causing a signal to be received by a main control module (MCM) in a controller area network of the vehicle which signal indicates to the MCM that a driver of the vehicle is braking, wherein the signal is caused by said means to be received by the MCM when the vehicle is determined to be speeding regardless of whether the driver of the vehicle is actually braking. The ISA system furthermore is configurable to limit the allowed speed of the vehicle to a speed determined based at least in part on a currently allowed speed for a speed zone applicable to a current location of the vehicle; and to limit the allowed speed of the vehicle to a nominal speed.

In a feature, the nominal speed results in the effective disengagement and nonoperation of the accelerator of the vehicle.

In a feature, the nominal speed is 1 kilometer per hour.

In a feature, the nominal speed is 1 mile per hour.

In a feature, the nominal speed is 5 miles per hour or less.

In another feature, the nominal speed corresponds to idling of the engine.

In another aspect, a vehicle comprises an intelligent speed adaptor (ISA) system, wherein the ISA system is configurable to limit the allowed speed of the vehicle to a speed determined based at least in part on a currently allowed speed for a speed zone applicable to a current location of the vehicle; and to limit the allowed speed of the vehicle to a nominal speed.

In another aspect, a vehicle comprises an intelligent speed adaptor (ISA) system, wherein the ISA system is configurable to limit the allowed speed of the vehicle to a speed determined based at least in part on a currently allowed speed for a speed zone applicable to a current location of the vehicle; and to limit the allowed speed of the vehicle to a speed corresponding to idling of the engine, whereby a motor vehicle under heavy load will be immobilized.

In a feature, the ISA system limits the speed of the vehicle by disengaging the acceleration pedal.

In a feature, the ISA system limits the speed of the vehicle by preventing signals indicating an acceleration from being sent to a main control module comprising an engine control unit.

In a feature, the ISA system limits the speed of the vehicle by preventing signals sent in response to depression of an acceleration pedal from being received by an engine control unit.

In a feature, the ISA system limits the speed of the vehicle by modifying signals that are sent in response to depression of an acceleration pedal to an engine control unit.

In a feature, the ISA system limits the speed of the vehicle by preventing signals sent by a throttle position sensor from being received by an engine control unit.

In a feature, the ISA system limits the speed of the vehicle by modifying signals sent by a throttle position sensor to an engine control unit.

In a feature, the ISA system limits the speed of the vehicle by sending commands to an engine control unit setting the vehicle's top speed governor.

In a feature, the ISA system is automatically configured to limit the allowed speed of the vehicle to a nominal speed based on the location of the vehicle and the time of day of the vehicle.

In a feature, the ISA system is automatically configured to limit the allowed speed of the vehicle to a nominal speed based on an external trigger.

In a feature, the external trigger comprises vehicle maintenance or electric logging device (ELD) compliance in conjunction with GPS location of the vehicle.

In a feature, the external trigger comprises the determination that a driver has exceeded his hours of service and the vehicle has entered a fleet terminal for pick up of another load, whereby the vehicle is effectively immobilized and the driver is unable to continue operating the vehicle outside of regulatory compliance.

In a feature, the external trigger comprises a determination that not all maintenance requirements have been met for maintenance of the vehicle when the vehicle is determined to be at a facility for performing the required maintenance.

In a feature, the external trigger comprises a determination, based on one or more tire sensors, that one or more tires require replacement.

In a feature, the ISA system limits the allowed speed of the vehicle based on a determination of regulatory noncompliance that is made from a driver profile and hours of service data acquired from an electronic logging device of the vehicle or from a telematics service provider.

In another aspect, a method for effectively immobilizing a vehicle comprises: first, receiving, at an intelligent speed adapter (ISA) system of a vehicle, an indication to set a maximum allowed speed of the vehicle to a value corresponding to idling of an engine of the vehicle, and based on the received indication, setting, by the ISA system, a value for a maximum allowed speed of the vehicle to the value corresponding to idling of the engine of the vehicle; and thereafter, following depression of an accelerator pedal of the vehicle, determining, by the ISA system, a current speed of the vehicle, determining, by the ISA system, the current maximum allowed speed of the vehicle, comparing the current speed of the vehicle to the current maximum allowed speed of the vehicle, which current maximum allowed speed is equal to the value corresponding to idling of the engine of the vehicle, based on the comparison of the current speed of the vehicle to the current maximum allowed speed of the vehicle, electronically hindering acceleration of the vehicle; whereby the vehicle is effectively immobilized by electronically hindering acceleration of the vehicle based on setting of the maximum allowed speed to the value corresponding to idling of the engine of the vehicle.

In a feature, electronically hindering acceleration of the vehicle comprises disengaging the acceleration pedal.

In a feature, electronically hindering acceleration of the vehicle comprises preventing signals indicating an acceleration from being sent to a main control module comprising an engine control unit.

In a feature, electronically hindering acceleration of the vehicle comprises preventing signals sent in response to depression of an acceleration pedal from being received by an engine control unit.

In a feature, electronically hindering acceleration of the vehicle comprises modifying signals that are sent in response to depression of an acceleration pedal to an engine control unit.

In a feature, electronically hindering acceleration of the vehicle comprises preventing signals sent by a throttle position sensor from being received by an engine control unit.

In a feature, electronically hindering acceleration of the vehicle comprises modifying signals sent by a throttle position sensor to an engine control unit.

In a feature, electronically hindering acceleration of the vehicle comprises sending commands to an engine control unit setting the vehicle's top speed governor.

In another aspect, a method for effectively immobilizing a vehicle comprises: first, receiving, at an intelligent speed adapter (ISA) system of a vehicle, an indication to immobilize the vehicle, and based on the received indication, setting, by the ISA system, a value for a maximum allowed speed of the vehicle to a value corresponding to idling of the engine of the vehicle; and thereafter, following depression of an accelerator pedal of the vehicle, determining, by the ISA system, a current speed of the vehicle, determining, by the ISA system, the current maximum allowed speed of the vehicle, comparing the current speed of the vehicle to the current maximum allowed speed of the vehicle, which current maximum allowed speed is equal to the value corresponding to idling of the engine of the vehicle, based on the comparison of the current speed of the vehicle to the current maximum allowed speed of the vehicle, electronically hindering acceleration of the vehicle; whereby the vehicle is effectively immobilized by electronically hindering acceleration of the vehicle based on setting of the maximum allowed speed to the value corresponding to idling of the engine of the vehicle.

In another aspect, a method for effectively immobilizing a vehicle comprises: first, determining, based on a driver profile and hours of service data acquired from an electronic logging device of the vehicle or from a telematics service provider, that a driver of a vehicle has exceeded his hours of service, and based on the received indication, setting, by an intelligent speed adapter (ISA) system of the vehicle, a value for a maximum allowed speed of the vehicle to a value corresponding to idling of the engine of the vehicle; and thereafter, following depression of an accelerator pedal of the vehicle, determining, by the ISA system, a current speed of the vehicle, determining, by the ISA system, the current maximum allowed speed of the vehicle, comparing the current speed of the vehicle to the current maximum allowed speed of the vehicle, which current maximum allowed speed is equal to the value corresponding to idling of the engine of the vehicle, based on the comparison of the current speed of the vehicle to the current maximum allowed speed of the vehicle, electronically hindering acceleration of the vehicle; whereby the vehicle is effectively immobilized by electronically hindering acceleration of the vehicle based on setting of the maximum allowed speed to the value corresponding to idling of the engine of the vehicle.

In another aspect, a method for effectively immobilizing a vehicle comprises: first, determining, based on a location of a vehicle and a time of day, that the vehicle should be immobilized, and based on the received indication, setting, by an intelligent speed adapter (ISA) system of the vehicle, a value for a maximum allowed speed of the vehicle to a value corresponding to idling of the engine of the vehicle; and thereafter, following depression of an accelerator pedal of the vehicle, determining, by the ISA system, a current speed of the vehicle, determining, by the ISA system, the current maximum allowed speed of the vehicle, comparing the current speed of the vehicle to the current maximum allowed speed of the vehicle, which current maximum allowed speed is equal to the value corresponding to idling of the engine of the vehicle, based on the comparison of the current speed of the vehicle to the current maximum allowed speed of the vehicle, electronically hindering acceleration of the vehicle; whereby the vehicle is effectively immobilized by electronically hindering acceleration of the vehicle based on setting of the maximum allowed speed to the value corresponding to idling of the engine of the vehicle.

In another aspect, a method for effectively immobilizing a vehicle comprises: first, based on a trigger, setting, by the ISA system, a value for a maximum allowed speed of the vehicle to a nominal value; and thereafter, following depression of an accelerator pedal of the vehicle, determining, by the ISA system, a current speed of the vehicle, determining, by the ISA system, the current maximum allowed speed of the vehicle, comparing the current speed of the vehicle to the current maximum allowed speed of the vehicle, based on the comparison of the current speed of the vehicle to the current maximum allowed speed of the vehicle, electronically hindering acceleration of the vehicle; whereby the vehicle is effectively immobilized by electronically hindering acceleration of the vehicle based on setting of the maximum allowed speed to the nominal value.

In addition to the aforementioned aspects and features of the present invention, it should be noted that the present invention further encompasses the various logical combinations and subcombinations of such aspects and features. Thus, for example, claims in this or a divisional or continuing patent application or applications may be separately directed to any aspect, feature, or embodiment disclosed herein, or combination thereof, without requiring any other aspect, feature, or embodiment.

### BRIEF DESCRIPTION OF THE DRAWINGS

One or more preferred embodiments of the present invention now will be described in detail with reference to the accompanying drawings, wherein the same elements are referred to with the same reference numerals, and wherein,

FIG. 1 is a schematic illustration of a prior art electronic network of a motor vehicle.

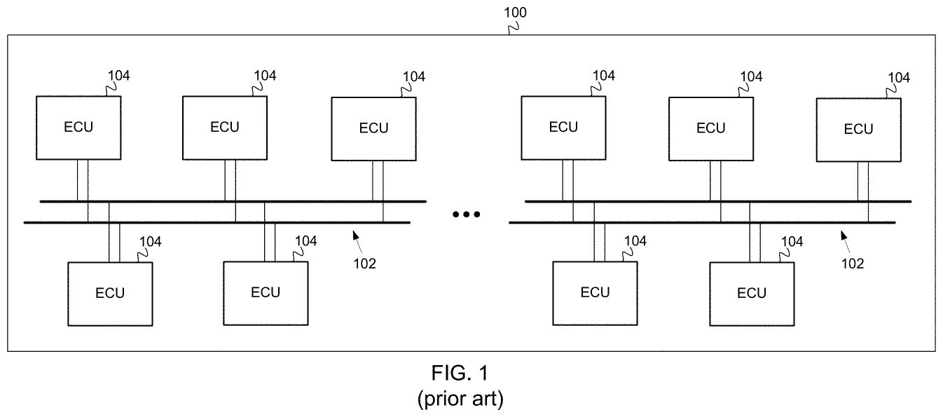

FIG. 2 is a schematic illustration of an embodiment of a prior art ISA system in accordance with the disclosure of the '133 patent.

FIG. 3 is a schematic illustration of another embodiment of a prior art ISA system in accordance with the disclosure of the '133 patent.

FIG. 4 is a schematic illustration of an embodiment in accordance with one or more aspects and features of the present invention.

FIG. 5 is a schematic illustration of another embodiment in accordance with one or more aspects and features of the present invention.

FIG. 6 is a schematic illustration of yet another embodiment in accordance with one or more aspects and features of the present invention.

FIG. 7 is a schematic illustration of a sequence of steps that are performed in accordance with one or more aspects and features of the present invention.

FIG. 8 is a schematic illustration of another sequence of steps that are performed in accordance with one or more aspects and features of the present invention.

FIG. 9 is a schematic illustration of yet another sequence of steps that are performed in accordance with one or more aspects and features of the present invention.

FIG. 10 shows an embodiment of a modified brake switch that has been installed on a Volvo tractor in accordance with one or more aspects and features of an embodiment of the present invention.

FIG. 11 shows an embodiment of a modified brake switch that has been installed on a Freightliner New Cascadia truck in accordance with one or more aspects and features of an embodiment of the present invention.

FIG. 12 illustrates an exemplary web portal that may be used to monitor and adjust settings for vehicles in an ISA system.

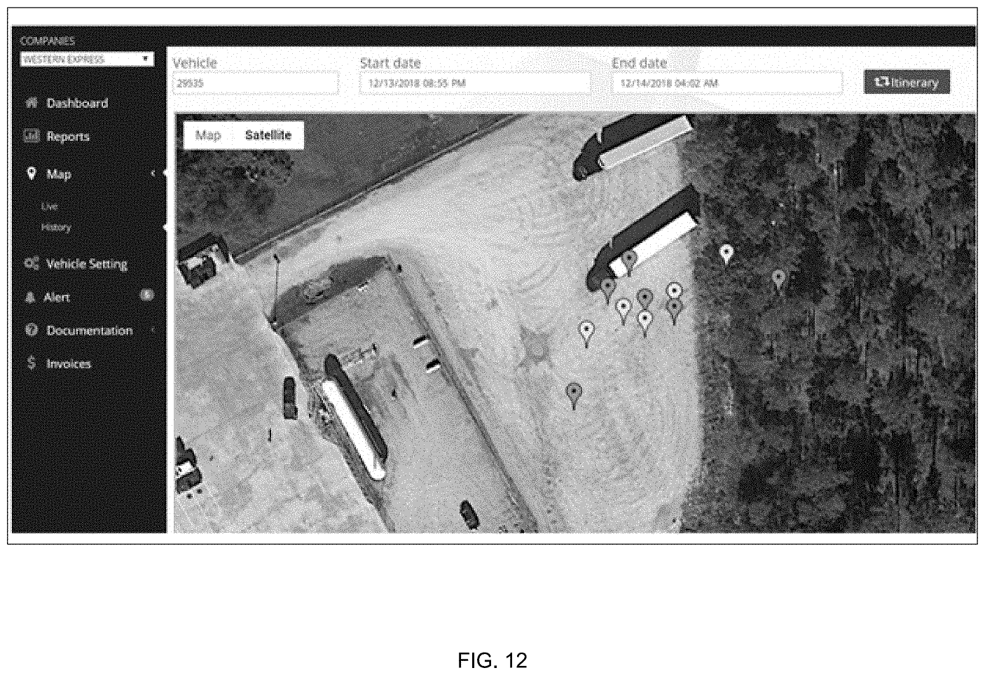

FIG. 13 illustrates a simplistic flow for a process in which a maximum allowed speed for a vehicle is set to a value corresponding to engine idling at step 610, and thereafter this set maximum allowed speed effectively immobilizes the vehicle based on hindering of acceleration of the vehicle.

FIG. 14 illustrates another simplistic flow for a process in which a vehicle is effectively immobilized based on a received indication to set a maximum allowed speed for a vehicle to a speed corresponding to idling of an engine of the vehicle.

FIG. 15 illustrates another simplistic flow for a process in which a vehicle is effectively immobilized based on a received indication to immobilize the vehicle.

FIG. 16 illustrates another simplistic flow for a process in which a vehicle is effectively immobilized based on a determination of regulatory noncompliance

FIG. 17 illustrates another simplistic flow for a process in which a vehicle is effectively immobilized based on a time of day and vehicle location

### DETAILED DESCRIPTION

As a preliminary matter, it will readily be understood by one having ordinary skill in the relevant art (“Ordinary Artisan”) that the invention has broad utility and application. Furthermore, any embodiment discussed and identified as being “preferred” is considered to be part of a best mode contemplated for carrying out the invention. Other embodiments also may be discussed for additional illustrative purposes in providing a full and enabling disclosure of the invention. Furthermore, an embodiment of the invention may incorporate only one or a plurality of the aspects of the invention disclosed herein; only one or a plurality of the features disclosed herein; or combination thereof. As such, many embodiments are implicitly disclosed herein and fall within the scope of what is regarded as the invention.

Accordingly, while the invention is described herein in detail in relation to one or more embodiments, it is to be understood that this disclosure is illustrative and exemplary of the invention and is made merely for the purposes of providing a full and enabling disclosure of the invention. The detailed disclosure herein of one or more embodiments is not intended, nor is to be construed, to limit the scope of patent protection afforded the invention in any claim of a patent issuing here from, which scope is to be defined by the claims and the equivalents thereof. It is not intended that the scope of patent protection afforded the invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the invention. Accordingly, it is intended that the scope of patent protection afforded the invention be defined by the issued claim(s) rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

With regard solely to construction of any claim with respect to the United States, no claim element is to be interpreted under 35 U.S.C. 112(f) unless the explicit phrase “means for” or “step for” is actually used in such claim element, whereupon this statutory provision is intended to and should apply in the interpretation of such claim element. With regard to any method claim including a condition precedent step, such method requires the condition precedent to be met and the step to be performed at least once but not necessarily every time during performance of the claimed method.

Furthermore, it is important to note that, as used herein, “comprising” is open-ended insofar as that which follows such term is not exclusive. Additionally, “a” and “an” each generally denotes “at least one” but does not exclude a plurality unless the contextual use dictates otherwise. Thus, reference to “a picnic basket having an apple” is the same as “a picnic basket comprising an apple” and “a picnic basket including an apple”, each of which identically describes “a picnic basket having at least one apple” as well as “a picnic basket having apples”; the picnic basket further may contain one or more other items beside an apple. In contrast, reference to “a picnic basket having a single apple” describes “a picnic basket having only one apple”; the picnic basket further may contain one or more other items beside an apple. In contrast, “a picnic basket consisting of an apple” has only a single item contained therein, i.e., one apple; the picnic basket contains no other item.

When used herein to join a list of items, “or” denotes “at least one of the items” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers”; the picnic basket further may contain one or more other items beside cheese and crackers.

When used herein to join a list of items, “and” denotes “all of the items of the list”. Thus, reference to “a picnic basket having cheese and crackers” describes “a picnic basket having cheese, wherein the picnic basket further has crackers”, as well as describes “a picnic basket having crackers, wherein the picnic basket further has cheese”; the picnic basket further may contain one or more other items beside cheese and crackers.

The phrase “at least one” followed by a list of items joined by “and” denotes an item of the list but does not require every item of the list. Thus, “at least one of an apple and an orange” encompasses the following mutually exclusive scenarios: there is an apple but no orange; there is an orange but no apple; and there is both an apple and an orange. In these scenarios if there is an apple, there may be more than one apple, and if there is an orange, there may be more than one orange. Moreover, the phrase “one or more” followed by a list of items joined by “and” is the equivalent of “at least one” followed by the list of items joined by “and”.

Referring now to the drawings, one or more preferred embodiments of the invention are next described. The following description of one or more preferred embodiments is merely exemplary in nature and is in no way intended to limit the invention, its implementations, or uses.

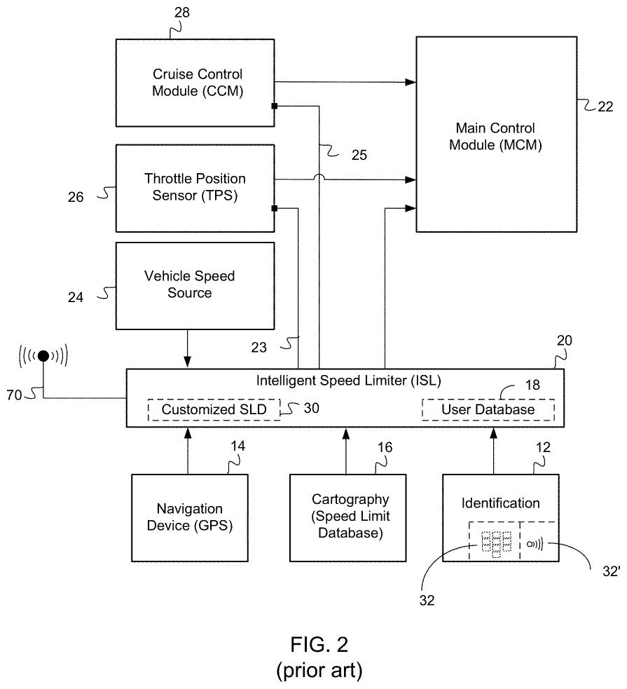

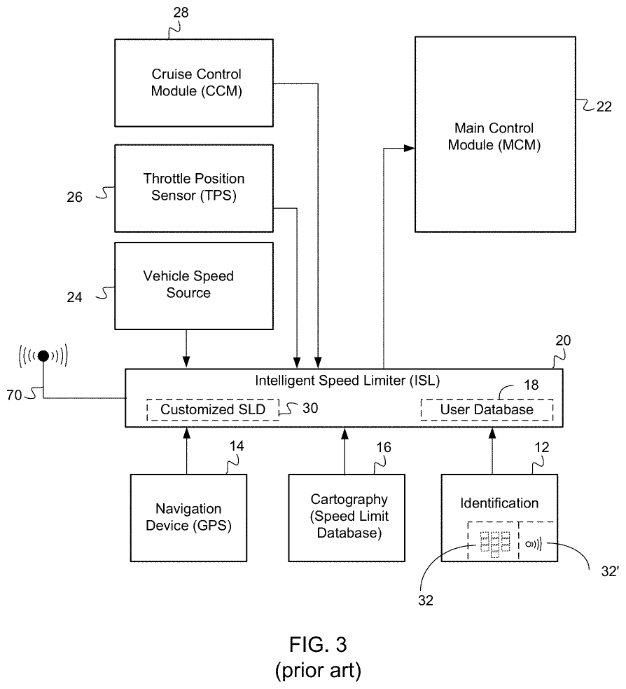

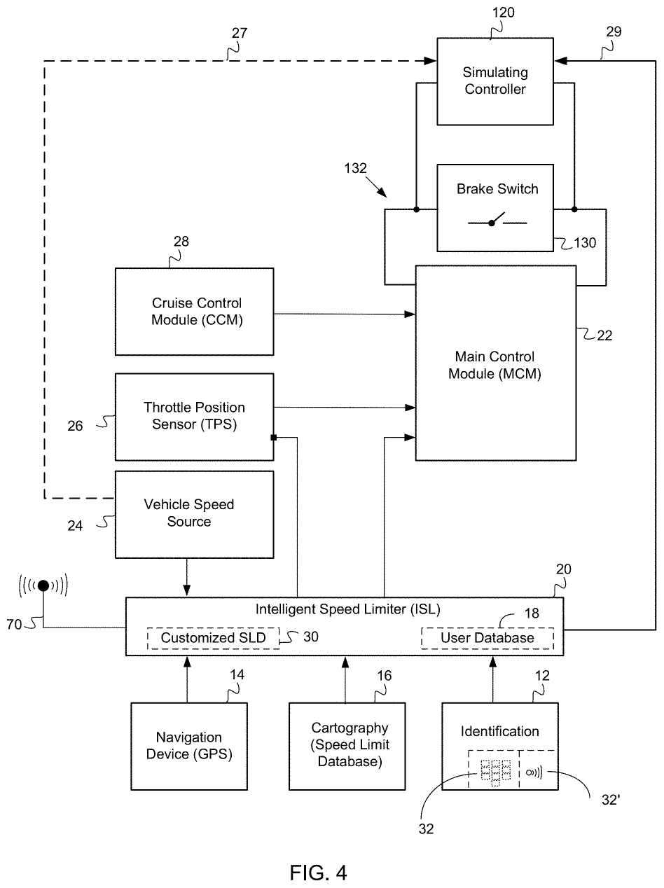

FIG. 4 is a schematic illustration of an embodiment in accordance with one or more aspects and features of the present invention. The embodiment of FIG. 4 includes many of the same elements as the ISA system of FIGS. 2 and 3, including an identification device 12 for identifying a driver; a navigation device (e.g. GPS device) 14; a cartography or speed limit database 16; a user database 18 of drivers; an intelligent speed limiter (ISL) module 20; a main control module (MCM) 22; a vehicle speed source 24; a throttle position sensor (TPS) module 26; and a cruise control module 28. A customized speed limit database 30; a keypad 32; and a wireless RFID reader 32′ also may be included as shown. Operation of these elements when the cruise control is not engaged may be as described above with regard to the ISA systems of FIGS. 2 and 3.

A difference that will first be noted is that the ISL module 20 in FIG. 4 does not control the cruise control module 28 and the signals that are sent from the cruise control module 28 to the MCM, which is done in the ISA system of FIG. 2. Nor is the cruise control module 28 separately connected to the ISL module 20 like in the ISA system of FIG. 3. Instead, the cruise control module 28 in FIG. 4 is connected to the data bus of the controller area network of the vehicle for communication via the data bus with the main control module 22.

Another difference is the inclusion of a controller or “simulating” controller 120 that mimics or simulates braking by a driver of the vehicle to the main control unit. In particular, the controller 120 may be communicatively coupled to the vehicle speed source 24 via the controller area network whereby a current speed of the vehicle is determined by the controller 120. This is schematically indicated by dashed line 27. Preferably, however, the vehicle speed is obtained by the controller 120 from the ISL module 20, as indicated by line 29. The currently allowed speed limit also preferably is obtained or otherwise determined by the controller 120 from information acquired from the ISL module 20. The controller 120 also monitors the data bus for whether the cruise control module 28 is active and cruise control is currently engaged. In some alternatives, the ISL module determines whether the vehicle is speeding and informs the simulating controller 120. In any case, when the simulating controller 120 determines that the cruise control is engaged and that the current speed of vehicle is within a range of or exceeds the currently allowed speed, the simulating controller 120 causes one or more signals to be sent to MCM 22, which one or more signals indicate to the MCM 22 that the brakes are being applied by the driver, thus simulating driver braking. This mimicking of driver braking results in consequent disengagement by the MCM 22 of the cruise control. Due to the operation of the simulating controller 128, the ISL module 20 is able to operate in a mode corresponding to operation as if there were no cruise control module 28. Nor is the resulting effectiveness of the ISL module 20 impacted by the presence and operation of the cruise control module—a benefit of the embodiment of the present invention for FIG. 4.

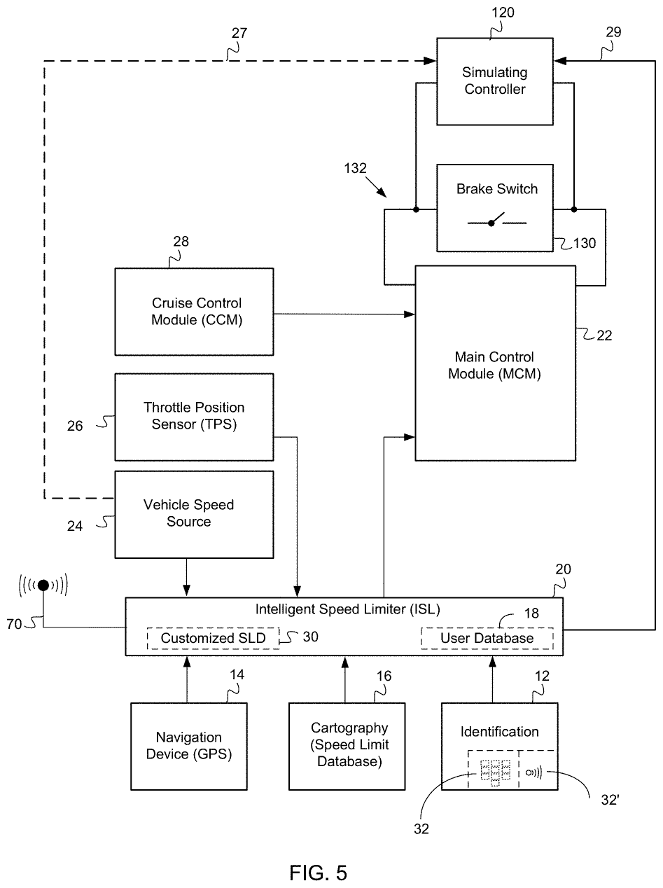

FIG. 5 is a schematic illustration of another embodiment in accordance with one or more aspects and features of the present invention. The embodiment of FIG. 5 includes many of same elements as that of FIG. 4 and principally differs in the arrangement of the throttle position sensor 26 relative to the ISL module 20. Specifically, this arrangement of the throttle position sensor 26 and ISL module 20 corresponds to that of FIG. 3. The arrangement of the throttle position sensor 26 and ISL module 20 of FIG. 2 similarly corresponds to that of FIG. 4.

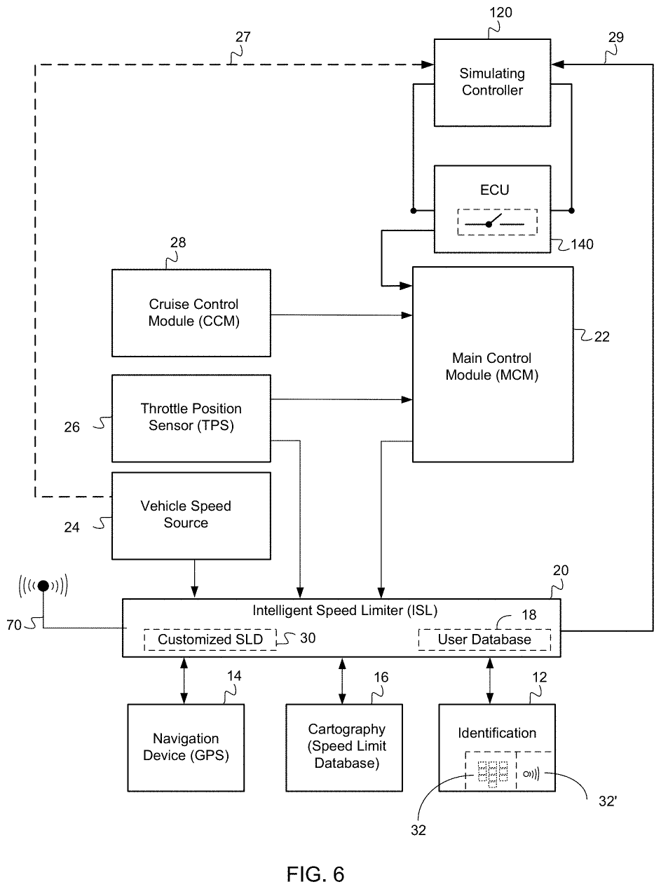

Continuing on with reference to the arrangement between the throttle position sensor 26 and ISL module 20, the arrangement of FIG. 6 is similar to that of FIG. 5. The embodiment of FIG. 6 in accordance with one or more aspects and features of the present invention differs from that of FIGS. 4 and 5 in how the simulating controller 120 simulates braking by the driver. In particular, in each of the foregoing embodiments described in connection with FIGS. 4-5, the simulating controller preferably bypasses operation of a brake switch of the vehicle. This is done by connecting the simulating controller in parallel with a circuit of brake switch 130 such that the simulating controller 120 closes the brake switch circuit 132 causing a signal to be generated indicating braking even though the brake switch 130 may not be in a closed position so as to complete the circuit 132 itself. The brake switch circuit 132 is connected to the MCM 22 whereby closing of the brake switch circuit 132 signals the MCM 22 that the driver is applying the brakes. Preferably the simulating controller 120 will maintain the closed circuit with current flowing therethrough so long as the simulating controller 120 determines that speeding is occurring. During the simulated braking, the MCM 22 also preferably causes the brake lights to be illuminated, too. In contrast, in the embodiment of FIG. 6 the simulating controller 120 interacts with the brake switch through ECU 140 which itself is communicatively coupled with the MCM 22 via the data bus of the controller area network.

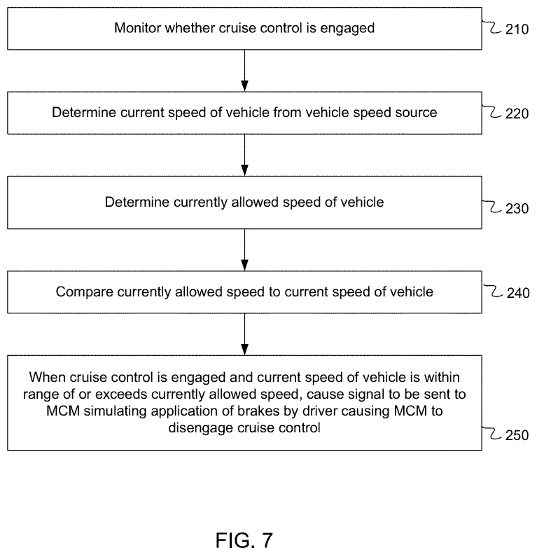

A sequence of steps is illustrated in FIG. 7, which steps are representative of an embodiment of a method in accordance with one or more aspects and features of the present invention. In step 210, whether cruise control is engaged is monitored. The step preferably is continuously performed. In step 220, the current speed of the vehicle is determined from the vehicle speed source. This step preferably is performed at short periodic intervals. Similarly, in step 230, the currently allowed speed of the vehicle is determined, which also is performed at short periodic intervals. In step 240, the currently allowed speed of the vehicle is compared to the current speed of vehicle, which step is preferably performed at short periodic intervals. When the cruise control is determined to be engaged and the current speed of the vehicle is determined to be within range of or exceed the determined currently allowed speed, a signal is caused to be sent to the MCM in step 250 that simulates application of the brakes by the driver, thereby resulting in disengagement by the MCM of the cruise control. Of course, as will be understood by the Ordinary Artisan, steps 210,220,230 may be performed in any order or concurrently, and the sequence of steps shown in FIG. 7 is not limiting.

In an alternative embodiment, the simulating controller is able to determine a set speed of the cruise control. This preferably is determined by communication with the MCM via the data bus. It is also contemplated that, while not preferred, this may be accomplished by communicatively coupling the simulating controller to the cruise control module such that a current set speed of the cruise control is thereby determined by the simulating controller. Such connection may be accomplished via the data bus. In either scenario, when the simulating controller determines that the cruise control is engaged and that the current cruise control set speed of vehicle is within a range of or exceeds the currently allowed speed, the simulating controller causes one or more signals to be sent to MCM which signals indicate to the MCM that the brakes are being applied by the driver, thereby simulating driver braking. Again, such mimicking of driver braking results in disengagement by the MCM of cruise control.

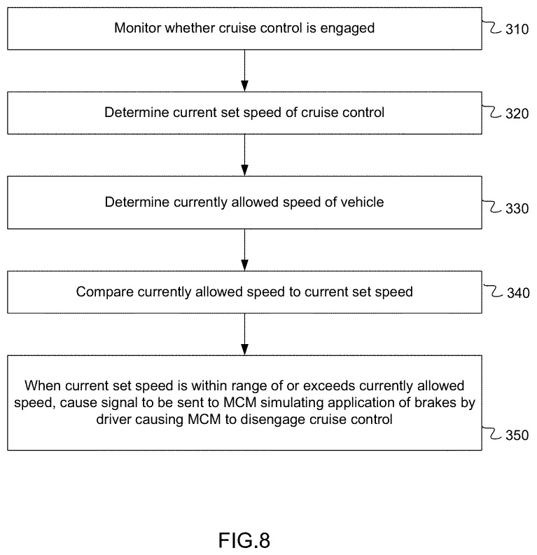

Such sequence of steps in this alternative embodiment is illustrated in FIG. 8. Specifically, in step 310, whether cruise control is engaged is monitored. This step preferably is continuously performed. In step 320, the current set speed of the cruise control for the vehicle is determined whether or not the cruise control is engaged. This step preferably is performed at short periodic intervals. Similarly, in step 330, the currently allowed speed of the vehicle is determined, which also is performed at short periodic intervals. In step 340, the currently allowed speed of the vehicle is compared to the current set speed, which step is preferably performed at short periodic intervals. When the cruise control is determined to be engaged and the current set speed of the cruise control is determined to be within range of or exceeds the determined currently allowed speed, a signal is caused to be sent to the MCM in step 350 that simulates application of the brakes by the driver, thereby resulting in disengagement by the MCM of the cruise control. This sequence of steps is believed to be preferential over the sequence of steps of FIG. 7 because there is no ambiguity whether the speeding is momentary due to the vehicle being on a downhill slope as opposed to being set at a speed that is over the currently allowed speed. Of course, as will be understood by the Ordinary Artisan, steps 310,320,330 may be performed in any order or concurrently, and the sequence of steps shown in FIG. 8 is not limiting.

In yet another alternative embodiment, the simulating controller is not communicatively coupled to the cruise control module and does not monitor whether the cruise control is actually engaged. In contrast, in the previously discussed embodiments the simulation of braking is performed only when cruise control is determined to be engaged. In this particular embodiment, however, the simulation of braking is not dependent on determination that cruise control is engaged. Instead, the simulating controller simply determines at short periodic intervals whether the current speed of the vehicle is within a range of or exceeds the currently allowed speed, and the simulating controller causes one or more signals to be sent to MCM which one or more signals indicate to the MCM that the brakes are being applied by the driver, thereby simulating driver braking. This mimicking of driver braking results in disengagement by the MCM of cruise control—if engaged. Moreover, such simulated braking also results in brake override, wherein conflicting signals being received by the MCM from the throttle position sensor are ignored by the MCM resulting in a decrease of or loss of acceleration in vehicle speed and consequent slowing of the vehicle until the detected speeding is abated. This would be similar to a driver depressing simultaneously the brake pedal and the accelerator pedal which, at least in some instances, cause the MCM to respond to the signals resulting from depression of the brake pedal while ignoring the signals resulting from the depression of the accelerator pedal.

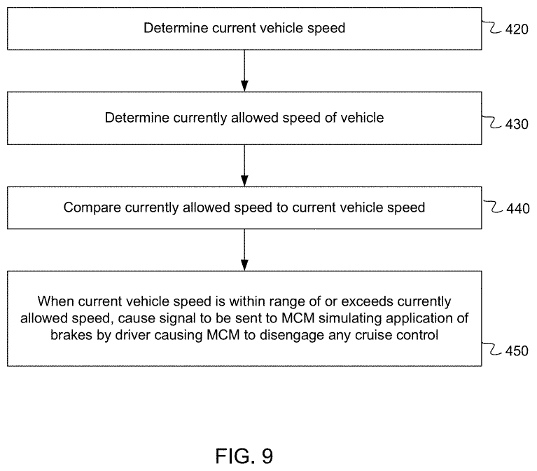

Such sequence of steps is illustrated in FIG. 9. Specifically, in step 420, the current set speed of the cruise control for the vehicle is determined irrespective of whether the cruise control is engaged. This step preferably is performed at short periodic intervals. Similarly, in step 430, the currently allowed speed of the vehicle is determined irrespective of whether the cruise control is engaged, which also is performed at short periodic intervals. In step 440, the currently allowed speed of the vehicle is compared to the current set speed irrespective of whether the cruise control is engaged, which step is preferably performed at short periodic intervals. When the current set speed of the vehicle is determined to be within range of or exceeds the determined currently allowed speed, a signal is caused to be sent to the MCM in step 450 that simulates application of the brakes by the driver irrespective of whether the cruise control is engaged; however, if cruise control is engaged, then such simulated braking results in disengagement of the cruise control. Of course, as will be understood by the Ordinary Artisan, steps 420,430 may be performed in any order or concurrently, and the sequence of steps shown in FIG. 9 is not limiting. Additionally, it will be appreciated that if the simulating controller is preprogrammed with one or more allowed speeds, or otherwise is able to determine an allowed speed (such as in the same or a similar way as the ISL module described with reference to FIGS. 2 and 3), then the operation of the simulating controller in accordance with FIG. 9 may result in limiting of the speed of the vehicle when used without and independent of the ISL module.

In the foregoing embodiment in which the set speed of the cruise control is not determined by the simulating controller, the simulating controller does not cause one or more signals to be sent to MCM simulating braking until after a predetermined period of time in which such determinations indicating speeding are made. Alternatively, the simulating controller does not cause one or more signals to be sent to MCM simulating braking until after a predetermined distance has been traveled, during which travel the determinations made by the simulating controller indicate speeding. Such time or distance buffer will avoid disengagement of the cruise control too quickly, which could annoy a driver. For example, a time or distance buffer is usefully used to prevent disengaging the cruise control during a short period of time or over a short distance that the vehicle is traveling downhill. Accordingly, minor speeding transgressions on a limited basis preferably will not result in disengagement of cruise control. On the other hand, a significant magnitude in a transgression regardless of a time or distance buffer preferably will result in disengagement of cruise control. Such a magnitude of speeding would be something that is not the result of simply traveling downhill or something that would legally be deemed reckless driving. For example, speeding by more than 50 km/hr in Canada—or 15 m/hr in the United States—of the currently allowed speed may be deemed to be such a magnitude of transgression so as to ignore any otherwise applicable time or distance buffer.

From the foregoing, it will be appreciated that embodiments of the present invention provide many benefits and advantages. One such advantage is that one or more embodiments of the present invention work well and are compatible with other ADA systems, including other ISA systems and including collision mitigation systems and lane departure systems, for example. Indeed, many embodiments of the present invention do not try to override such other systems and will act only if the vehicle is exceeding the configured speed limit while cruise control is engaged.

Also, this method of disengaging the cruise control avoids directly sending a message on the data bus to the MCM/ECM to disengage the cruise control. Sending messages on the data bus, as opposed to only reading messages from the data bus, is disfavored by OEMs and systems that only read message are favored. In many embodiments of the present invention, the simulating controller only reads data from the data bus and thus would be a favored system by such OEMs. The advantage of using the brake switch method to disengage the cruise control is that the simulating controller only need to cause current to flow through the brake switch circuit, thereby causing the MCM to disengage the cruise control without the simulating circuit signaling the MCM itself via the data bus.

Nonetheless, in less preferred embodiments, it is still contemplated that the simulating controller does communicate with the MCM/ECM, sending commands directly to the MCM/ECM to disengage the cruise control, but requires an understanding of the protocol of each different vehicle model. Also sending a wrong signal to the MCM/ECM can have undesired consequences, such as creating an engine code. Going through the brake switch circuit is therefore believed to be both safer for the MCM/ECM and more universal in commercial applications.

Another benefit is that by avoiding taking over control of the cruise control (as in a disclosed ISA system of the '133 patent), difficulties can be avoided where other ADA systems that work with the OEM cruise control, such as adaptive cruise control, would likely no longer work and would be overridden. Such incompatibility with other ADA systems is believed to be a serious hinderance to adoption and commercialization of such ISA system of the '133 patent.

In view of the foregoing, it thus will be appreciated by the Ordinary Artisan that the cruise control can be disengaged by simply simulating a brake switch signal. Simulating the brake switch signal will automatically disengage any cruise control and allow ISA systems and other ADA systems to continue properly functioning should the driver try to bypass such systems through the cruise control, while not having to program or otherwise account for different cruise control systems. By simply simulating the brake switch signal, the cruise control is disengaged when the vehicle goes above the configured speed limit while continuing to limit the accelerator pedal.

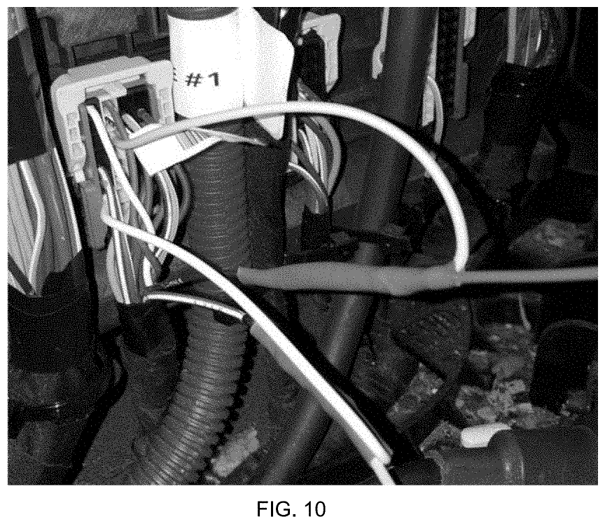

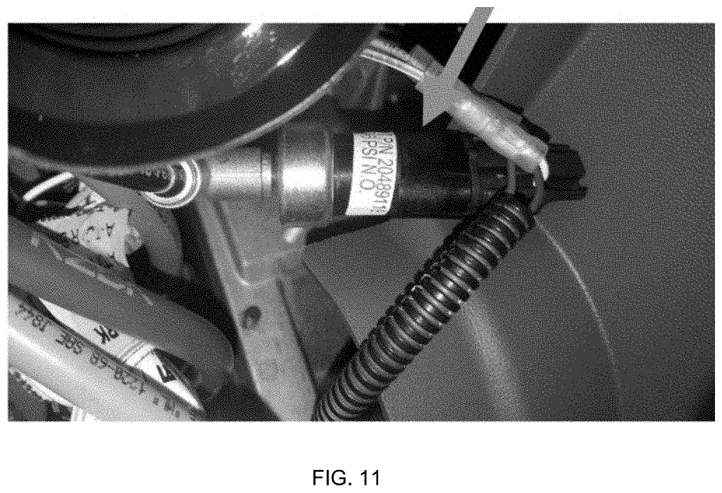

Embodiments of the present invention have been reduced to practice. In this regard, FIG. 10 shows a modification to a brake switch that has been installed on a Volvo tractor in accordance with one or more aspects and features of an embodiment of the present invention. FIG. 11 shows an alternative modification that has been installed on a Freightliner New Cascadia truck in accordance with one or more aspects and features of an embodiment of the present invention. In particular, in vehicles such as the Freightliner New Cascadia truck, a simulating controller cannot be connected directly to a brake switch and, in those situations, a simulating controller is connected to an ECU with which the brake switch is connected whereby the simulating controller still is able to cause a signal to be generated indicating braking by a driver to the MCM. An exemplary ECU is a surrogate safety assessment model (SSAM) of the Freightliner New Cascadia.

Such security features of an ISA system are advantageous, especially in view of the fact that these are byproducts of the design of the ISA system and do not accomplish the principal intent of the ISA system of speed-limit compliance by drivers. Nonetheless, to the extent further security features or other benefits can be realized by repurposing use of an ISA system, such extension of the utility of ISA systems would be considered advantageous. One or more aspects and features of the present invention are believed to provide just

Regarding the extension of the utility of ISA systems, it has been discovered that ISA systems can be repurposed for providing additional security features as well as furthering regulatory compliance and satisfaction of maintenance requirements. Such extension of ISA systems is now discussed.

An ISA system is configurable to limit the allowed speed of the vehicle to a speed determined based at least in part on a currently allowed speed for a speed zone applicable to a current location of the vehicle. Accordingly, a plurality of different allowed speeds generally are specified for the plurality of different speed zones through which a vehicle may travel. It has been realized that such an ISA system may be repurposed by configuring the ISA system to allow a different maximum allowed speed for each of a plurality of different speed zones, and further configured the ISA system to allow an override of a single maximum allowed speed for all of the plurality of different speed zones. In conjunction therewith, and in accordance with the present invention relating to such extension of ISA systems, the single maximum allowed speed of the override preferably corresponds to a nominal speed that effectively immobilizes the vehicle. Such nominal speed may be a speed that corresponds to idling of the engine, whereby a motor vehicle under heavy load will be effectively immobilized; a that results in the effective disengagement and nonoperation of the accelerator of the vehicle by the ISA system; a speed approximately equal to about 1 kilometer per hour, about 1 mile per hour, or about 5 miles per hour.

The ISA system preferably limits the speed of the vehicle by disengaging the acceleration pedal; by preventing signals indicating an acceleration from being sent to a main control module comprising an engine control unit; by preventing signals sent in response to depression of an acceleration pedal from being received by an engine control unit; by modifying signals that are sent in response to depression of an acceleration pedal to an engine control unit; by preventing signals sent by a throttle position sensor from being received by an engine control unit; or by modifying signals sent by a throttle position sensor to an engine control unit. Alternatively, the ISA system limits the speed of the vehicle by sending commands to an engine control unit setting the vehicle's top speed governor. In a feature, the ISA system is automatically configured to limit the allowed speed of the vehicle to a nominal speed based on the location of the vehicle and the time of day of the vehicle.

The ISA system preferably is configured to send and receive communications to and from a remote computer accessible over the Internet using a wireless communication device, which is schematically represented by device 70 in FIGS. 4-6. The ISA system preferably is configured through a user interface provided by a computer on the Internet. Accordingly, a fleet operator thus may immobilize a desired vehicle remotely through a web portal provided by the remote computer accessible over the Internet by setting the allowed speed of the vehicle to a speed corresponding to a nominal speed, i.e., a speed “in name only”

In preferred embodiments, a program is executed by the remote computer accessible over the Internet for immobilizing a vehicle by setting the allowed speed of the vehicle to a speed corresponding to idling of the engine upon determination of a predetermined event or an external trigger. The predetermined event may comprise a determination that maintenance of the vehicle is required; a determination that operation of the vehicle by an identified driver would be out of compliance with legal regulations; or a determination that operation of the vehicle by an identified driver would exceed an allotted number of hours of operation of the vehicle by the driver. An external trigger may comprise vehicle maintenance or electric logging device (ELD) compliance in conjunction with GPS location of the vehicle; a determination that a driver has exceeded his hours of service and the vehicle has entered a fleet terminal for pick up of another load, whereby the vehicle is effectively immobilized and the driver is unable to continue operating the vehicle outside of regulatory compliance; a determination that not all maintenance requirements have been met for maintenance of the vehicle when the vehicle is determined to be at a facility for performing the required maintenance; a determination, based on one or more tire sensors, that one or more tires require replacement; and a determination of regulatory noncompliance that is made from a driver profile and hours of service data acquired from an electronic logging device of the vehicle or from a telematics service provider.

At least in some embodiments, a vehicle in accordance with embodiments of the invention relating to such extension and repurposing of ISA systems preferably comprises an intelligent speed adaptor (ISA) system; and means for causing a signal to be received by a main control module (MCM) in a controller area network of the vehicle which signal indicates to the MCM that a driver of the vehicle is braking, wherein the signal is caused by said means to be received by the MCM when the vehicle is determined to be speeding regardless of whether the driver of the vehicle is actually braking. The ISA system furthermore is configurable to limit the allowed speed of the vehicle to a speed determined based at least in part on a currently allowed speed for a speed zone applicable to a current location of the vehicle; and to limit the allowed speed of the vehicle to a nominal speed.

Additionally, at least in some embodiments, a vehicle in accordance with embodiments of the invention relating to such extension and repurposing of ISA systems preferably comprises an intelligent speed adaptor (ISA) system, wherein the ISA system is configurable to limit the allowed speed of the vehicle to a speed determined based at least in part on a currently allowed speed for a speed zone applicable to a current location of the vehicle; and to limit the allowed speed of the vehicle to a nominal speed.

Furthermore, at least in some embodiments, a vehicle in accordance with embodiments of the invention relating to such extension and repurposing of ISA systems preferably comprises an intelligent speed adaptor (ISA) system, wherein the ISA system is configurable to limit the allowed speed of the vehicle to a speed determined based at least in part on a currently allowed speed for a speed zone applicable to a current location of the vehicle; and to limit the allowed speed of the vehicle to a speed corresponding to idling of the engine, whereby a motor vehicle under heavy load will be immobilized.

Systems and apparatus have been described herein for use in methodologies involving setting a maximum allowed speed for a vehicle and electronically preventing or hindering acceleration of the vehicle beyond that maximum allowed speed. Methodologies in accordance therewith will now be discussed.

In accordance with one or more preferred implementations, such a maximum allowed speed is set at a nominal value or a value corresponding to idling of an engine of a vehicle in order to effectively disable a vehicle.

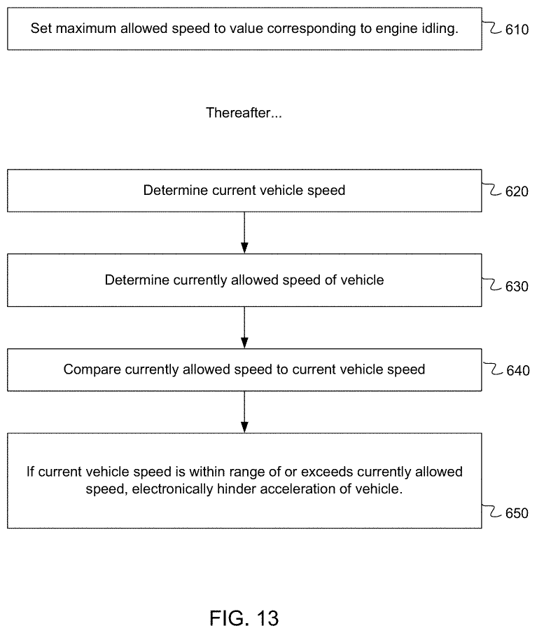

For example, FIG. 13 illustrates a simplistic flow for a process in which a maximum allowed speed for a vehicle is set to a value corresponding to engine idling at step 610, and thereafter this set maximum allowed speed effectively immobilizes the vehicle based on hindering of acceleration of the vehicle. In particular, at step 620, a current vehicle speed is determined. This step preferably is performed at short periodic intervals. Similarly, at step 630, the current maximum allowed speed of the vehicle is determined, which step also is preferably performed at short periodic intervals. At step 640, the current maximum allowed speed of the vehicle is compared to the current vehicle speed, which step is preferably also performed at periodic intervals. At step 650, if the current speed of the vehicle is determined to be within range of or exceed the determined current maximum allowed speed, electronic hindering of acceleration of the vehicle is effected. Because the maximum allowed speed is set to a value corresponding to engine idling, this acts to effectively immobilize the vehicle if the vehicle is under heavy load, as any attempt to accelerate the vehicle will be hindered. As will be understood by an ordinary artisan, steps 420,430 may be performed in any order or concurrently, and the sequence of steps shown in FIG. 13 is not limiting.

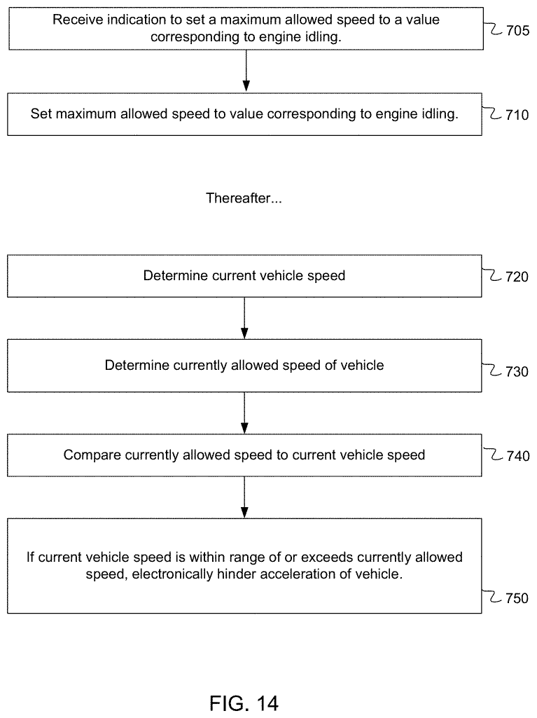

FIG. 14 illustrates another simplistic flow for a process in which a vehicle is effectively immobilized based on a received indication to set a maximum allowed speed for a vehicle to a speed corresponding to idling of an engine of the vehicle. In particular, at step 705, an ISA system receives an indication to set a maximum allowed speed for a vehicle to a speed corresponding to idling of an engine of the vehicle. At step 710, the maximum allowed speed for the vehicle is set to the value corresponding to engine idling. At step 720, a current vehicle speed is determined. This step preferably is performed at short periodic intervals. Similarly, at step 730, the current maximum allowed speed of the vehicle is determined, which step also is preferably performed at short periodic intervals. At step 740, the current maximum allowed speed of the vehicle is compared to the current vehicle speed, which step is preferably also performed at periodic intervals. At step 750, if the current speed of the vehicle is determined to be within range of or exceed the determined current maximum allowed speed, electronic hindering of acceleration of the vehicle is effected. Because the maximum allowed speed is set to a value corresponding to engine idling, this acts to effectively immobilize the vehicle if the vehicle is under heavy load, as any attempt to accelerate the vehicle will be hindered. As will be understood by an ordinary artisan, steps 720,730 may be performed in any order or concurrently, and the sequence of steps shown in FIG. 14 is not limiting.

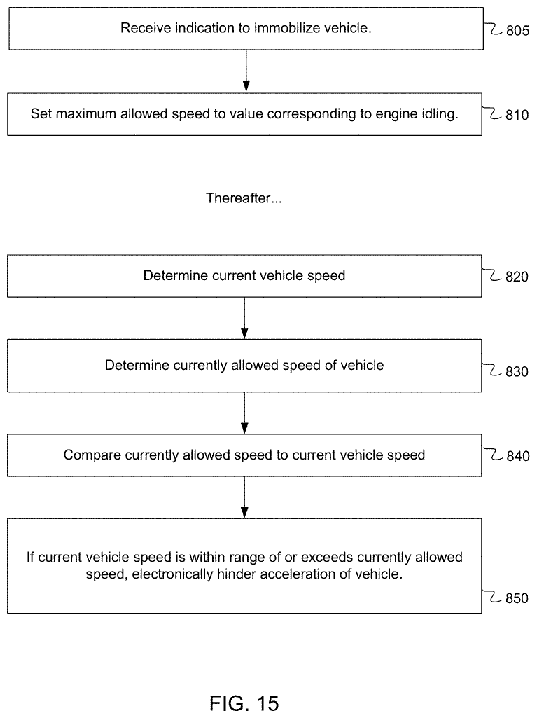

FIG. 15 illustrates another simplistic flow for a process in which a vehicle is effectively immobilized based on a received indication to immobilize the vehicle. In particular, at step 805, an ISA system receives an indication to immobilize the vehicle. At step 810, a maximum allowed speed for the vehicle is set to a value corresponding to engine idling. At step 820, a current vehicle speed is determined. This step preferably is performed at short periodic intervals. Similarly, at step 830, the current maximum allowed speed of the vehicle is determined, which step also is preferably performed at short periodic intervals. At step 840, the current maximum allowed speed of the vehicle is compared to the current vehicle speed, which step is preferably also performed at periodic intervals. At step 850, if the current speed of the vehicle is determined to be within range of or exceed the determined current maximum allowed speed, electronic hindering of acceleration of the vehicle is effected. Because the maximum allowed speed is set to a value corresponding to engine idling, this acts to effectively immobilize the vehicle if the vehicle is under heavy load, as any attempt to accelerate the vehicle will be hindered. As will be understood by an ordinary artisan, steps 820,830 may be performed in any order or concurrently, and the sequence of steps shown in FIG. 15 is not limiting.

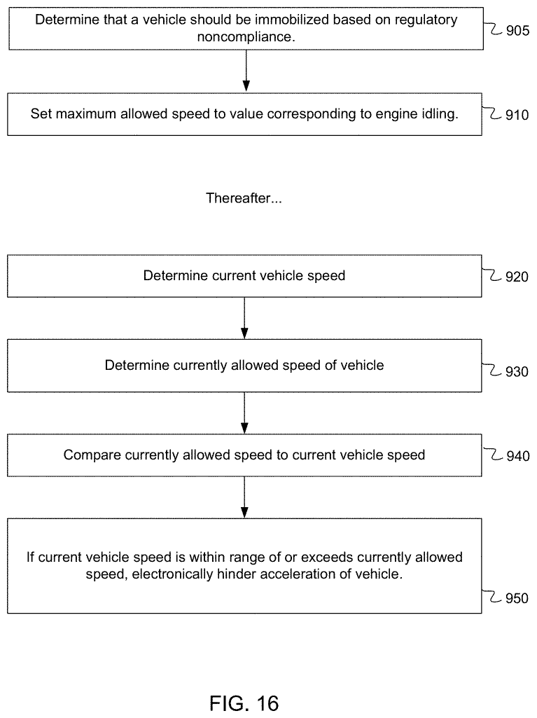

FIG. 16 illustrates another simplistic flow for a process in which a vehicle is effectively immobilized based on a determination of regulatory noncompliance. In particular, at step 905, an ISA system determines regulatory noncompliance. At step 910, a maximum allowed speed for the vehicle is set to a value corresponding to engine idling. At step 920, a current vehicle speed is determined. This step preferably is performed at short periodic intervals. Similarly, at step 930, the current maximum allowed speed of the vehicle is determined, which step also is preferably performed at short periodic intervals. At step 940, the current maximum allowed speed of the vehicle is compared to the current vehicle speed, which step is preferably also performed at periodic intervals. At step 950, if the current speed of the vehicle is determined to be within range of or exceed the determined current maximum allowed speed, electronic hindering of acceleration of the vehicle is effected. Because the maximum allowed speed is set to a value corresponding to engine idling, this acts to effectively immobilize the vehicle if the vehicle is under heavy load, as any attempt to accelerate the vehicle will be hindered. As will be understood by an ordinary artisan, steps 920,930 may be performed in any order or concurrently, and the sequence of steps shown in FIG. 16 is not limiting.

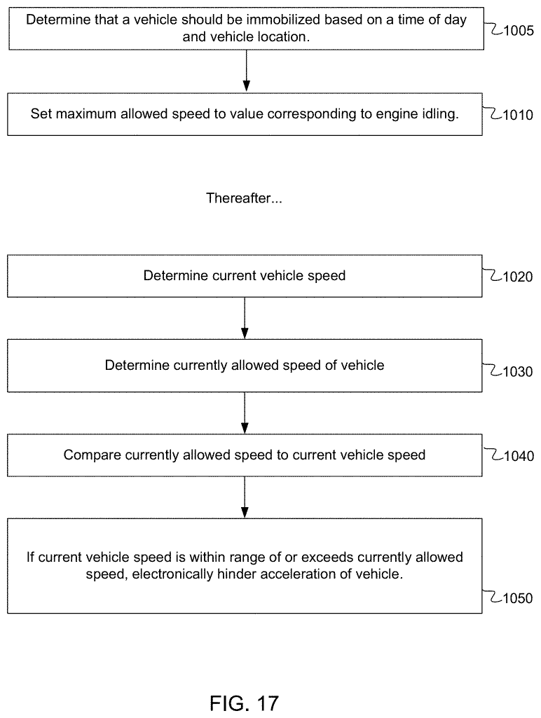

FIG. 17 illustrates another simplistic flow for a process in which a vehicle is effectively immobilized based on a time of day and vehicle location. In particular, at step 1005, an ISA system determines that the vehicle should be immobilized based on a time of day and vehicle location. At step 1010, a maximum allowed speed for the vehicle is set to a value corresponding to engine idling. At step 1020, a current vehicle speed is determined. This step preferably is performed at short periodic intervals. Similarly, at step 1030, the current maximum allowed speed of the vehicle is determined, which step also is preferably performed at short periodic intervals. At step 1040, the current maximum allowed speed of the vehicle is compared to the current vehicle speed, which step is preferably also performed at periodic intervals. At step 1050, if the current speed of the vehicle is determined to be within range of or exceed the determined current maximum allowed speed, electronic hindering of acceleration of the vehicle is effected. Because the maximum allowed speed is set to a value corresponding to engine idling, this acts to effectively immobilize the vehicle if the vehicle is under heavy load, as any attempt to accelerate the vehicle will be hindered. As will be understood by an ordinary artisan, steps 1020,1030 may be performed in any order or concurrently, and the sequence of steps shown in FIG. 17 is not limiting.

Based on the foregoing description, it will be readily understood by those persons skilled in the art that the present invention has broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Thus, for example, while the simulating controller has been described in connection with embodiments of an ISA system of the '133 patent, it will be appreciated that embodiments of the present invention are not limited to use with or incorporate of such an ISA system.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

1. A motor vehicle, comprising:
(a) an intelligent speed adaptor (ISA) system; and
(b) means for causing a signal to be received by a main control module (MCM) in a controller area network of the vehicle which signal indicates to the MCM that a driver of the vehicle is braking, wherein the signal is caused by said means to be received by the MCM when the vehicle is determined to be speeding regardless of whether the driver of the vehicle is actually braking;
(c) wherein the ISA system is configurable:
(i) to limit the allowed speed of the vehicle to a speed determined based at least in part on a currently allowed speed for a speed zone applicable to a current location of the vehicle; and
(ii) to limit the allowed speed of the vehicle to a speed corresponding to idling of the engine, whereby a motor vehicle under heavy load will be immobilized.

2. The motor vehicle of claim 1, wherein the ISA system is configured to send and receive communications to and from a remote computer accessible over the Internet, and wherein the ISA system is configured through a user interface provided by a computer on the Internet.

3. (canceled)

4. The motor vehicle of claim 2, wherein the ISA system is configured to allow a different maximum allowed speed for each of a plurality of different speed zones, and is configured to allow an override of a single maximum allowed speed for all of the plurality of different speed zones, the single maximum allowed speed of the override corresponding to idling of the engine.

5. The motor vehicle of claim 2, wherein a fleet operator can immobilize the vehicle remotely through a web portal provided by the remote computer accessible over the Internet by setting the allowed speed of the vehicle to a speed corresponding to idling of the engine.

6. The motor vehicle of claim 2, wherein a program executed by the remote computer accessible over the Internet immobilizes the vehicle by setting the allowed speed of the vehicle to a speed corresponding to idling of the engine upon determination of a predetermined event.

7-16. (canceled)

17. A vehicle, comprising an intelligent speed adaptor (ISA) system, wherein the ISA system is configurable: (i) to limit the allowed speed of the vehicle to a speed determined based at least in part on a currently allowed speed for a speed zone applicable to a current location of the vehicle; and (ii) to limit the allowed speed of the vehicle to a speed corresponding to idling of the engine, whereby a motor vehicle under heavy load will be immobilized.

18. The motor vehicle of claim 17, wherein the ISA system limits the speed of the vehicle by disengaging the acceleration pedal.

19. The motor vehicle of claim 17, wherein the ISA system limits the speed of the vehicle by preventing signals indicating an acceleration from being sent to a main control module comprising an engine control unit.

20. The motor vehicle of claim 17, wherein the ISA system limits the speed of the vehicle by preventing signals sent in response to depression of an acceleration pedal from being received by an engine control unit.

21. The motor vehicle of claim 17, wherein the ISA system limits the speed of the vehicle by modifying signals that are sent in response to depression of an acceleration pedal to an engine control unit.

22. The motor vehicle of claim 17, wherein the ISA system limits the speed of the vehicle by preventing signals sent by a throttle position sensor from being received by an engine control unit.

23. The motor vehicle of claim 17, wherein the ISA system limits the speed of the vehicle by modifying signals sent by a throttle position sensor to an engine control unit.

24. The motor vehicle of claim 17, wherein the ISA system limits the speed of the vehicle by sending commands to an engine control unit setting the vehicle's top speed governor.

25. The motor vehicle of claim 17, wherein the ISA system is automatically configured to limit the allowed speed of the vehicle to a nominal speed based on the location of the vehicle and the time of day of the vehicle.

26. The motor vehicle of claim 17, wherein the ISA system is automatically configured to limit the allowed speed of the vehicle to a nominal speed based on an external trigger.

27. The motor vehicle of claim 17, wherein the external trigger comprises vehicle maintenance or electric logging device (ELD) compliance in conjunction with GPS location of the vehicle.

28. The motor vehicle of claim 17, wherein the external trigger comprises the determination that a driver has exceeded his hours of service and the vehicle has entered a fleet terminal for pick up of another load, whereby the vehicle is effectively immobilized and the driver is unable to continue operating the vehicle outside of regulatory compliance.

29. The motor vehicle of claim 17, wherein the external trigger comprises a determination that not all maintenance requirements have been met for maintenance of the vehicle when the vehicle is determined to be at a facility for performing the required maintenance.

30. The motor vehicle of claim 17, wherein the external trigger comprises a determination, based on one or more tire sensors, that one or more tires require replacement.

31. The motor vehicle of claim 30, wherein the ISA system limits the allowed speed of the vehicle based on a determination of regulatory noncompliance that is made from a driver profile and hours of service data acquired from an electronic logging device of the vehicle or from a telematics service provider.

32-43. (canceled)
